(19) United States
(12) Patent Application Publication
(10) Pub. No.: US 2012/0075358 A1
(43) Pub. Date: Mar. 29, 2012

(54) DISPLAY APPARATUS

(75) Inventors: Kazuyuki Shirai, Shijonawate City (JP); Tsuyoshi Hasegawa, Daito City (JP)

(73) Assignee: SANYO ELECTRIC CO., LTD., Moriguchi city (JP)

(21) Appl. No.: 13/233,529

(22) Filed: Sep. 15, 2011

(30) Foreign Application Priority Data
Sep. 28, 2010 (JP) 2010-217957

(51) Int. Cl. G09G 5/10

(52) U.S. Cl. 345/690; 345/82

(57) ABSTRACT

A display apparatus includes: a display panel; an LED backlight unit that emits light to the display panel; an LED driver that drives an LED of the LED backlight unit; an LED temperature detection portion that detects an LED temperature of the LED backlight unit; and a correction portion that based on a detection result from the LED temperature detection portion, corrects an image signal to be supplied to the display panel to compensate for a color temperature change of the LED backlight unit.

This nonprovisional application claims priority under 35 U.S.C. §119(a) on Patent Application No. 2010-217957 filed in Japan on Sep. 28, 2010, the entire contents of which are hereby incorporated by reference.

### BACKGROUND OF THE INVENTION

1. Field of the Invention

The present invention relates to a display apparatus, more particularly, to a display apparatus that includes an LED backlight unit.

2. Description of the Related Art

In a display apparatus (e.g., a transmissive liquid crystal display apparatus) that includes: a display panel; and a backlight unit that shines light onto the display panel from a rear surface of the display panel, in a case where the display apparatus has a relatively large-size screen like a T.V. receiver, a structure is general, in which fluorescent lamps such as a CCFL (Cold Cathode Fluorescent Lamp), an EEFL (External Electrode Fluorescent Lamp) and the like are used as the backlight.

However, in recent years, from the viewpoint of an environmental problem and the like, a display apparatus that uses an LED (Light Emitting Diode) having power consumption smaller than the fluorescent lamp for a light source of the backlight unit, that is, a display apparatus that has an LED backlight unit is attracting attention.

However, in the LED backlight unit, a tint of the LED changes in accordance with a temperature, so that there are problems that if the temperature of the LED changes, the color temperature of the LED backlight also changes and the characteristics of the LED backlight do not become stable.

Here, among conventional display apparatuses, there is a display apparatus which because a use temperature environment influences the speed of a characteristic change in the display apparatus, measures the use temperature near a liquid crystal display panel by means of a temperature sensor; and considering the use temperature environment as a parameter, performs image-quality adjustment in accordance with an integrated operation time (converted integrated operation time) in a case of a standard temperature condition.

The display apparatus performs the image-quality adjustment in accordance with the integrated operation time that is an index of a deterioration condition, so that if the LED temperature changes under the same deterioration condition, that is, during the same converted integrated operation time (e.g, 0 hours), the color temperature of the LED backlight changes. In other words, the display apparatus is not able to solve the above problems.

### SUMMARY OF THE INVENTION

A display apparatus according to the present invention includes: a display panel; an LED backlight unit that emits light to the display panel; an LED driver that drives an LED of the LED backlight unit; an LED temperature detection portion that detects an LED temperature of the LED backlight unit; and a correction portion that based on a detection result from the LED temperature detection portion, corrects an image signal to be supplied to the display panel to compensate for a color temperature change of the LED backlight unit.

Significance and effects of the present invention will be more apparent from description of embodiments described below. However, the following embodiments are mere embodiments of the present invention; and the present invention and the meanings of the terms for respective constituent elements are not limited to the description of the following embodiments.

### BRIEF DESCRIPTION OF THE DRAWINGS

FIG. 1 is a view showing a main portion of a television receiver according to a first embodiment of the present invention.

FIG. 2 is a block diagram showing a schematic structure of the television receiver according to the first embodiment of the present invention.

FIG. 3 is a view showing a structural example of an LED driver.

FIG. 4 is a flow chart showing operation of a CPU related to a decision on a color temperature correction value.

FIG. 5 is a view showing a relationship between a drive voltage output from an LED driver and an LED temperature.

FIG. 6 is a view showing a relationship between an LED temperature and a chromaticity shift amount of a display image due to a color temperature change of LED backlight; and a relationship between an LED temperature and a temperature correction value.

FIG. 7 is a view showing a relationship between a panel operation integrated time of a liquid crystal display panel and a chromaticity shift amount of a display image due to deterioration of the liquid crystal display panel; and a relationship between a panel operation integrated time of a liquid crystal display panel and a deterioration correction value.

FIG. 8 is a view showing a main structure of a television receiver according to a second embodiment of the present invention

FIG. 9 is a block diagram showing a schematic structure of the television receiver according to the second embodiment of the present invention.

FIG. 10 is a flow chart showing operation of a CPU related to a decision on a color temperature correction value.

### DETAILED DESCRIPTION OF PREFERRED EMBODIMENTS

Embodiments of the present invention are described hereinafter with reference to the drawings.

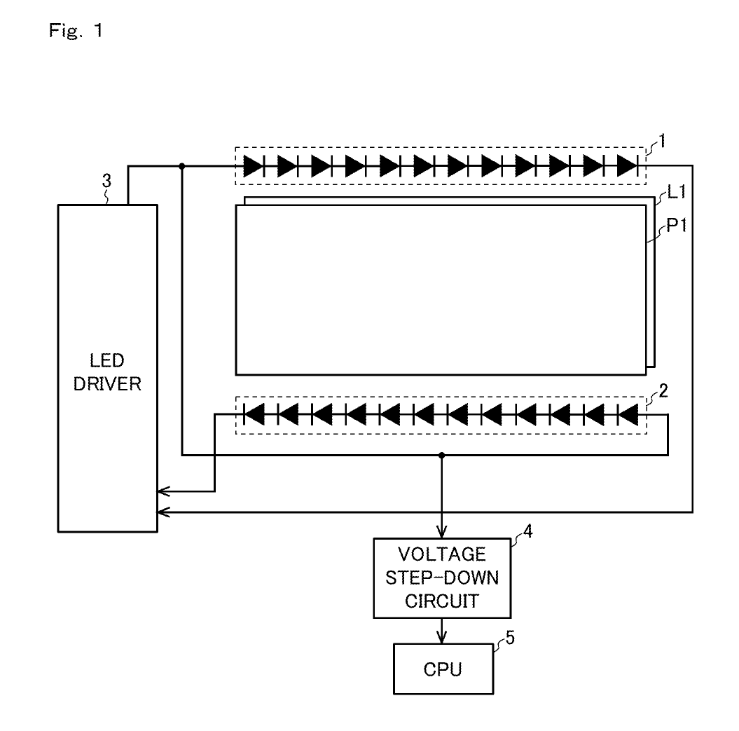

First, a television receiver according to a first embodiment of the present invention is described. A main structure of the television receiver according to the first embodiment of the present invention is shown in FIG. 1. The television receiver according to the first embodiment of the present invention includes an edge-type LED backlight unit. The edge-type LED backlight unit is composed of: a first LED-backlight LED module 1 that is a series connection circuit of a plurality of LEDs; a second LED-backlight LED module 2 that is likewise a series connection circuit of a plurality of LEDs; and a light guide plate L1.

The first LED-backlight LED module 1 and the second LED-backlight LED module 2 are connected in parallel with each other; and are driven (operated) by a drive voltage output from an LED driver 3. The light guide plate L1 guides light, which is emitted from the first LED-backlight LED module 1 and the second LED-backlight LED module 2, to a liquid crystal display panel P1.

Further, in the television receiver according to the first embodiment of the present invention, a voltage step-down circuit 4 steps down the drive voltage output from the LED driver 3 to a voltage that a CPU (Central Processing Unit) 5 for controlling the entire television receiver is able to directly read; and supplies the voltage to the CPU 5. Although details are described later, according to this structure, the CPU 5 is able to compute an LED temperature of the edge-type LED backlight unit.

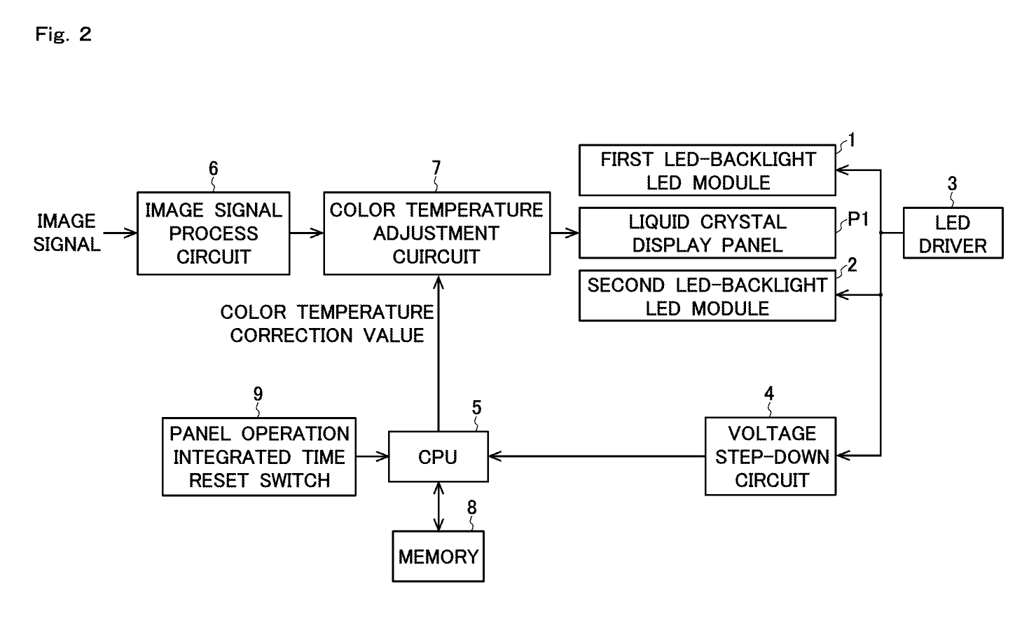

Next, a schematic structure of the television receiver according to the first embodiment of the present invention is shown in FIG. 2. Here, in FIG. 2, the same portions as those in FIG. 1 are indicated by the same reference numbers.

As shown in FIG. 2, the television receiver according to the first embodiment of the present invention includes: the first LED-backlight LED module 1; the second LED-backlight LED module 2; the LED driver 3; the voltage step-down circuit 4; the CPU 5; an image signal process circuit 6; a color temperature adjustment circuit 7; a memory 8; a panel operation integrated time reset switch 9; and the liquid crystal display panel P1. Besides, the television receiver according to the first embodiment of the present invention includes also: a digital tuner; a demultiplexer; an AV decoder; a voice signal process circuit (none of them are shown). Here, in the present embodiment, the voltage step-down circuit 4 and the CPU 5 correspond to an LED temperature detection portion that is described in claims; and the CPU 5, the color temperature adjustment circuit 7 and the memory 8 correspond to a correction portion that is described in claims.

The digital tuner converts a high-frequency signal from an antenna into a digital modulation signal, as a specific-frequency signal, for a selected physical channel. Besides, the digital tuner includes a demodulation circuit and the like that demodulate the digital modulation signal for the selected physical channel; and outputs a transport stream.

The demultiplexer decodes a ciphered packet of packets of the transport stream that is received from the digital tuner; divides the packet into AV data that is content of a broadcast program and SI (Service Information) information; and outputs the AV data to the Av decoder and the SI information to the CPU 5.

The AV decoder, in accordance with an AV control signal output from the CPU 5, decodes the AV data received from the demultiplexer into an image signal and a voice signal; and outputs the image signal to the image signal process circuit 6 and the voice signal to the voice signal process circuit.

The image signal process circuit 6 applies various processes to the image signal received from the AV decoder to generate an RGB signal and sends the RGB signal to the color temperature adjustment circuit 7.

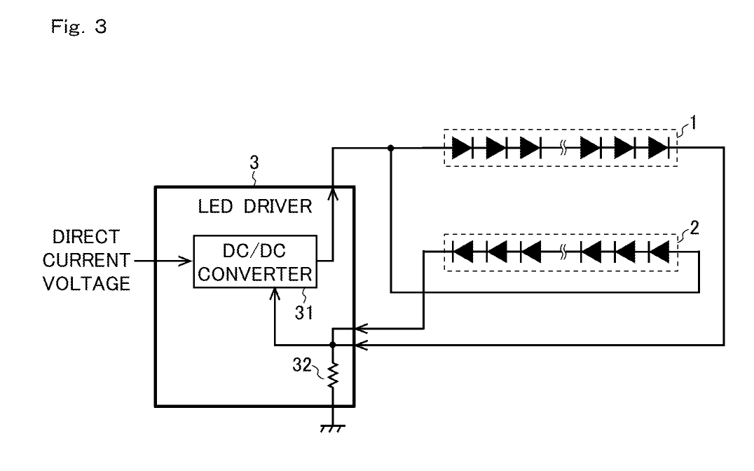

The color temperature adjustment circuit 7, based on the color temperature correction value received from the CPU 5, changes an RGB ratio of the RGB signal and sends the RGB signal after the change of the RGB ratio to the liquid crystal display panel P1. According to this, an image is displayed on the liquid crystal display panel P1. Here, brightness of the liquid crystal display panel P1 depends on brightness of the LED backlight; and the brightness of the LED backlight depends on a value of a constant electric current that is output from the LED driver 3 to the first LED-backlight LED module 1 and the second LED-backlight LED module 2. Here, a structural example of the LED driver 3 is shown in FIG. 3. In the structural example shown in FIG. 3, the LED driver 3 includes: a DC/DC converter 31; and an electric current detection resistor 32. The electric current detection resistor 32 feeds back a voltage, which is proportional to a total electric current of an electric current flowing in the first LED-backlight LED module 1 and an electric current flowing in the second LED-backlight LED module 2, to the DC/DC converter 31. The DC/DC converter 31 applies feedback control to the output voltage such that the total electric current of the electric current flowing in the first LED-backlight LED module 1 and the electric current flowing in the second LED-backlight LED module 2 becomes a constant electric current. The value of the constant electric current is decided in accordance with an instruction from the CPU 5.

The memory 8 stores, in non-volatile fashion, various programs and various data that the CPU 5 requires to perform various types of control of the television receiver.

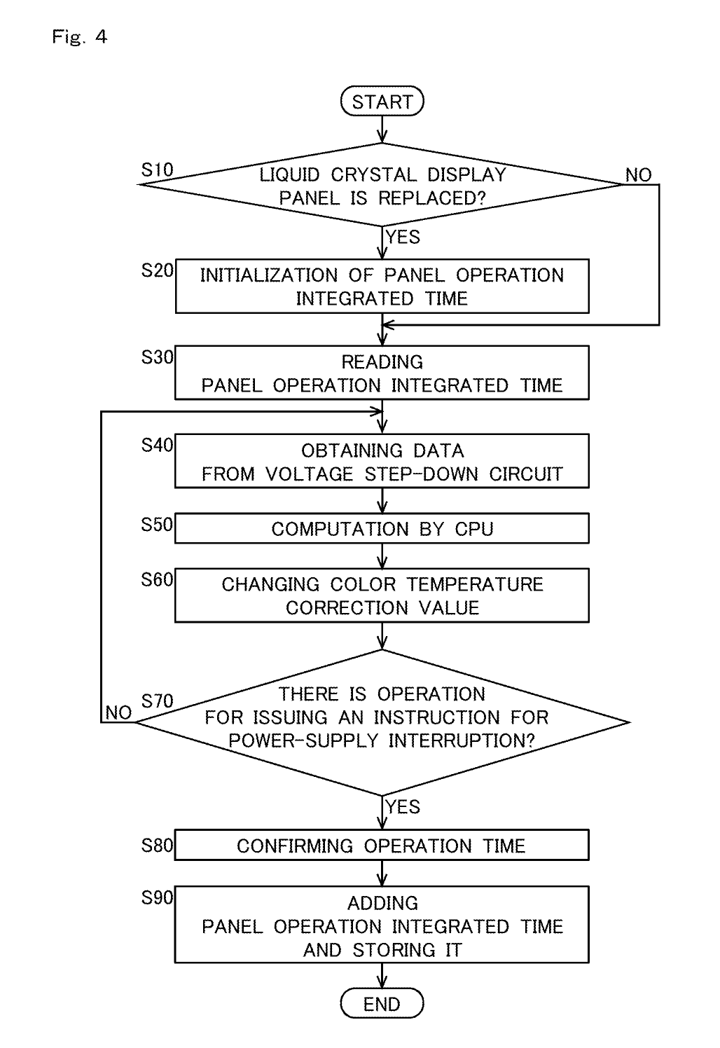

The CPU 5 uses a look-up table stored in the memory 8 to decide the color temperature correction value to be sent to the color temperature adjustment circuit 7. Operation of the CPU 5 related to the decision on the color temperature correction value is described hereinafter with reference to a flown chart in FIG. 4.

If a power supply of the television receiver according to the first embodiment of the present invention goes into an on state, the flow chart operation shown in FIG. 4 is started. At the start time of the flow chart operation, the CPU 5 uses an incorporated timer to start to count the operation time of the liquid crystal display panel P1.

First, the CPU 5 determines whether the liquid crystal display panel P1 is replaced or not (step S10). In the present embodiment, if the panel operation integrated time reset switch 9 is pushed before a predetermined time elapses after the power supply is switched from an off state to an on state, it is determined that the liquid crystal display panel P1 is replaced, while if the panel operation integrated time reset switch 9 is not pushed even if the predetermined time elapses after the power supply is switched from the off state to the on state, it is determined that the liquid crystal display panel P1 is not replaced.

In the case where it is determined that the liquid crystal display panel P1 is replaced (YES in the step S10), the CPU 5 performs initialization (reset) of the panel operation integrated time stored in the memory 8 (step S20); thereafter, goes to a step S30. On the other hand, in the case where it is determined that the liquid crystal display panel 1 is not replaced (NO in the step S10), the CPU 5 directly goes to the step S30.

In the step S30, the CPU 5 reads the panel operation integrated time stored in the memory 8. In a step S40 that follows the step S30, the CPU 5 obtains data output from the voltage step-down circuit 4. In a step S50 that follows the step S40, computation by the CPU 5 is performed.

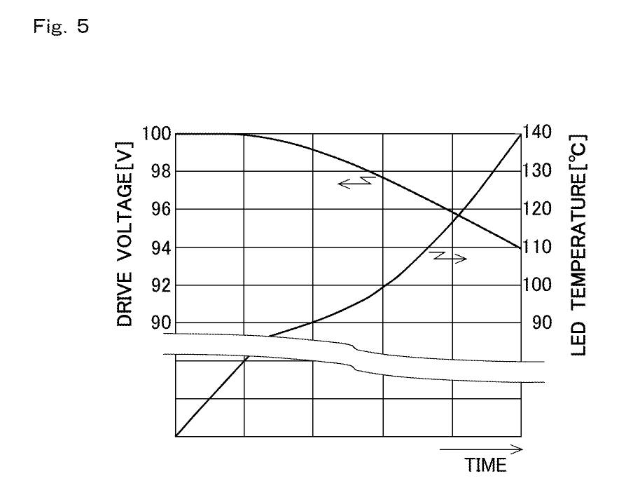

The LED driver 3 is of constant electric-current output type, so that there is a relationship as shown in FIG. 5 between the drive voltage output from the LED driver 3 and the LED temperature of the first LED-backlight LED module 1 and the second LED-backlight LED module 2. Because of this, in the computation process in the step S50, the CPU 5 uses the data obtained in the step S40 to detect the LED temperature of the first LED-backlight LED module 1 and the second LED-backlight LED module 2.

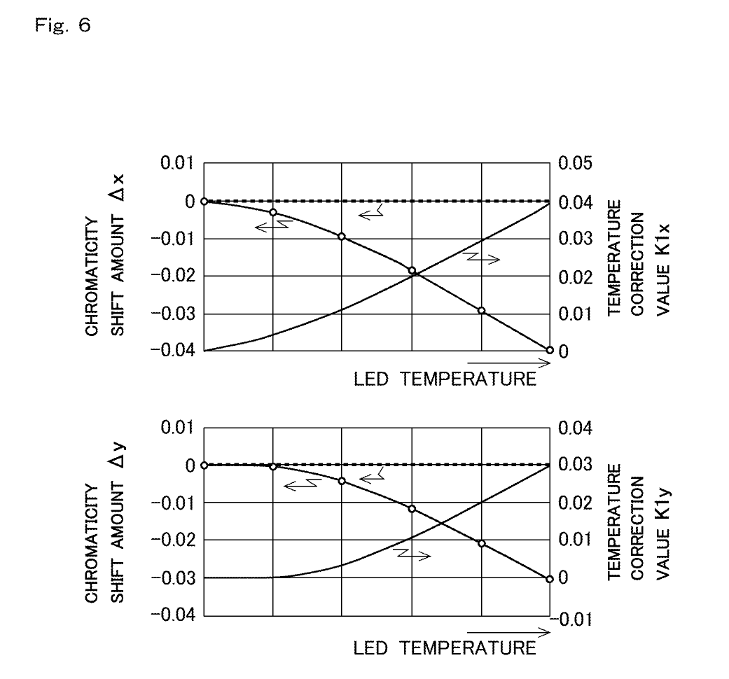

Between the LED temperature and the chromaticity shift amount of the display image due to the color temperature change of the LED backlight, there is a relationship as shown in FIG. 6; and by compensating for the color temperature change of the LED backlight by means of temperature correction values K1x and K1y, it is possible to nullify the chromaticity shift amount of the display image due to the color temperature change of the LED backlight as indicated by dotted lines shown in FIG. 6. The memory 8 stores in advance a first look-up table that indicates a corresponding relationship between the LED temperature and the temperature correction values K1x and K1y. Because of this, in the computation process in the step S50, the CPU 5 decides the temperature correction values K1x and K1y, which correspond to the detected LED temperature, with reference to the above first look-up table.

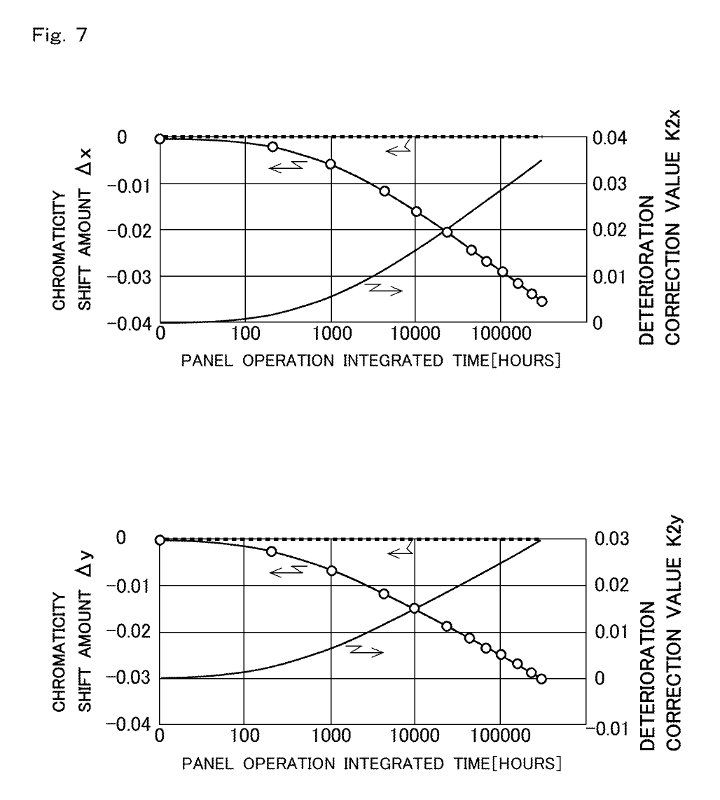

Besides, between the panel operation integrated time of the liquid crystal display panel P1 and the chromaticity shift amount of the display image due to deterioration of the liquid crystal display panel P1, there is a relationship as shown in FIG. 7; and by compensating for the deterioration of the liquid crystal display panel P1 by means of deterioration correction values K2x and K2y, it is possible to nullify the chromaticity shift amount of the display image due to the deterioration of the liquid crystal display panel P1 as indicated by dotted lines shown in FIG. 7. The memory 8 stores in advance a second look-up table that indicates a corresponding relationship between the panel operation integrated time of the liquid crystal display panel P1 and the deterioration correction values K2x and K2y. Because of this, in the computation process in the step S50, the CPU 5 decides the deterioration correction values K2x and K2y, which correspond to the panel operation integrated time that is read out in the step S30, with reference to the above second look-up table.

In a final stage of the computation process in the step S50, the CPU 5 computes color temperature correction values (K1x+K2x, K1y+K2y). And, in a step S60 that follows the step S50, the CPU 5 changes the color temperature correction values to be output to the color temperature adjustment circuit 7 in accordance with the computation result obtained in the step S50.

In a step S70 that follows the step S60, the CPU 5 determines whether there is an operation for issuing a command for a power-supply interruption or not. If there is not the operation for issuing a command for a power-supply interruption (NO in the step S70), the CPU 5 returns to the step S40, while if there is the operation for issuing a command for a power-supply interruption (YES in the step S70), the CPU 5 goes to a step S80.

In the step S80, the CPU 5 confirms the operation time of the liquid crystal display panel P1; in a step S90 that follows the step S80, the CPU 5 uses a time, which is obtained by adding the operation time of the liquid crystal display panel P1 to the panel operation integrated time of the liquid crystal display panel P1, as a new panel operation integrated time of the liquid crystal display panel P1 to update the panel operation integrated time of the liquid crystal display panel P1 stored in the memory 8; thereafter, ends the flow chart operation.

According to the above operation, the color temperature change of the LED backlight and the deterioration of the liquid crystal display panel P1 are compensated; and the chromaticity shift amount of the display image is curbed. Besides, the television receiver according to the first embodiment of the present invention, unlike a television receiver described later according to a second embodiment of the present invention, has the structure that does not use a temperature sensor for detection of the LED temperature, so that there are not problems described hereinafter which the television receiver described later according to the second embodiment of the present invention has. In this point, the television receiver according to the first embodiment of the present invention is preferable compared with the television receiver described later according to the second embodiment of the present invention.

<Problems that the Television Receiver According to the Second Embodiment of the Present Invention has>
(1) An expensive temperature sensor is used, which is disadvantageous in terms of cost.
(2) A disposition position of the temperature sensor is influenced by a set chassis, so that it is not always possible to dispose the temperature sensor at a suitable position; and there is a risk that the color temperature change of the LED backlight is not well compensated.
(3) It is necessary to perform disposition design for every set, so that a long time is required for the set development.

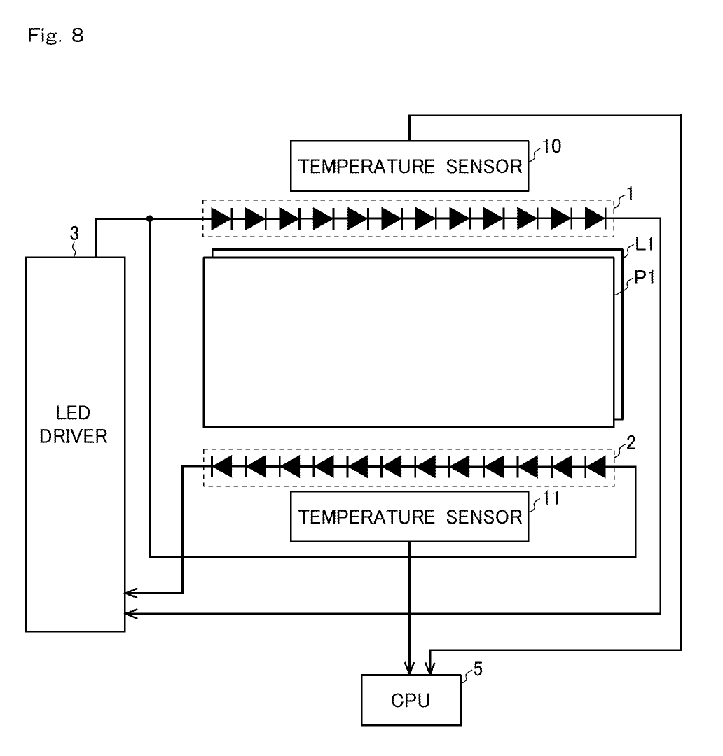

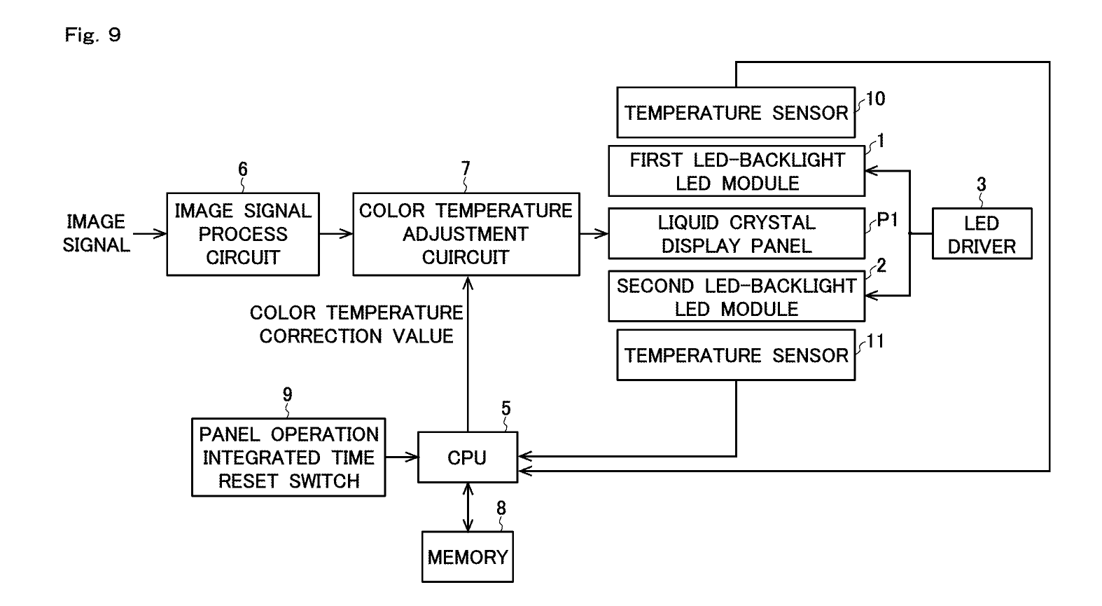

Next, the television receiver according to the second embodiment of the present invention is described. A main structure of the television receiver according to the second embodiment of the present invention is shown in FIG. 8; and a schematic structure of the television receiver according to the second embodiment of the present invention is shown in FIG. 9. Here, in FIG. 8 and FIG. 9, the same portions as those in FIG. 1 and FIG. 2 are indicated by the same reference numbers and detailed description is skipped.

The television receiver according to the second embodiment of the present invention has a structure in which the voltage step-down circuit 4 is removed from the television receiver according to the first embodiment of the present invention; and instead of the voltage step-down circuit 4, temperature sensors 10 and 11 are disposed. Here, in the present embodiment, the CPU 5, the temperature sensors 10 and 11 correspond to the LED temperature detection portion described in claims; and the CPU 5, the color temperature adjustment circuit 7, and the memory 8 correspond to the correction portion described in claims.

The temperature sensor 10 is disposed on the liquid crystal display panel P1, in more detail, near the first LED-backlight LED module 1, while the temperature sensor 11 is disposed under the liquid crystal display panel P1, in more detail, near the second LED-backlight LED module 2. Under influence of thermal convection, an upper side of the liquid crystal display panel P1 tends to be higher in temperature than a lower side of the liquid crystal display panel P1, so that it is insufficient to dispose the temperature sensor at only one of the upper and lower positions, accordingly, as in the present embodiment, it is necessary to dispose the temperature sensors at both of the upper and lower positions of the liquid crystal display panel P1.

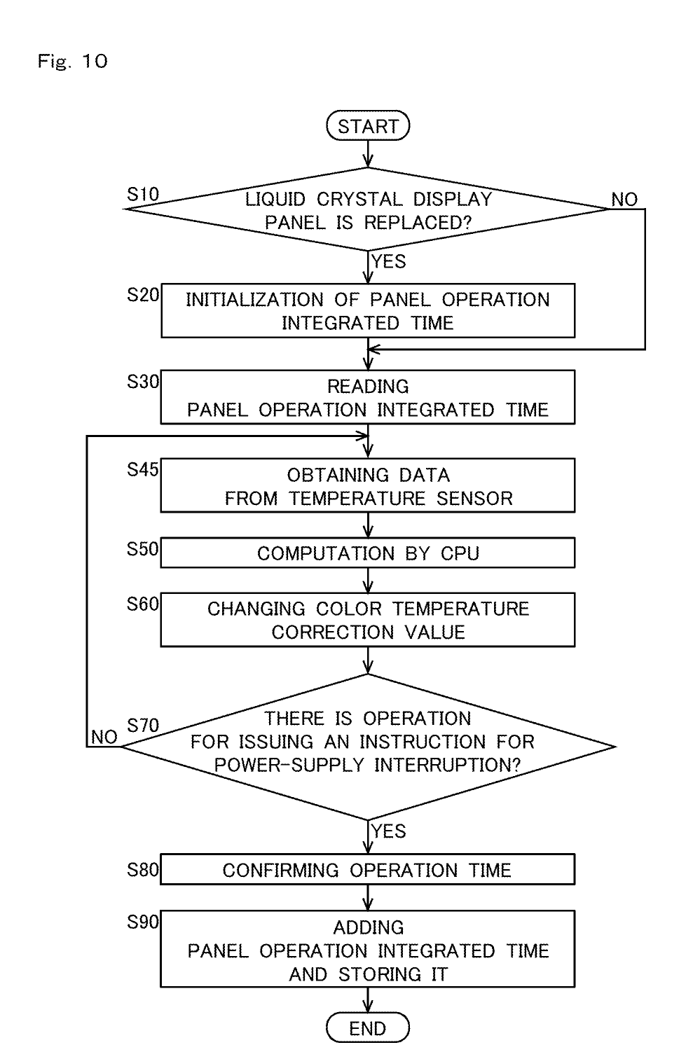

In the present embodiment, the CPU 5, based on signals output from the temperature sensors 10 and 11, detects the LED temperatures of the first LED-backlight LED module 1 and the second LED-backlight LED module 2. Because of this, in the present embodiment, operation of the CPU 5 related to the decision on the color temperature correction value is as indicated by a flow chart shown in FIG. 10. Here, in the flow chart shown in FIG. 10, the same steps as those in the flow chart shown in FIG. 4 are indicated by the same reference numbers and detailed description is skipped.

The flow chart shown in FIG. 10 is a flow chart in which the step S40 is removed from the flow chart shown in FIG. 4; and instead of the step S40, a step S45 is disposed.

The operations of the steps S 10 to S30 are the same as the first embodiment, accordingly, the description is skipped.

In the step S45, the CPU 5 obtains data output from the temperature sensors 10 and 11. In the step S50 that follows the step S45, computation by the CPU 5 is performed.

In the computation process in the step S50, the CPU 5 uses the data obtained in the step S45 to detect an average value of the LED temperatures of the first LED-backlight LED module 1 and the second LED-backlight LED module 2.

Between the LED temperature and the chromaticity shift amount of the display image due to the color temperature change of the LED backlight, there is the relationship as shown in FIG. 6; and by compensating for the color temperature change of the LED backlight by means of the temperature correction values K1x and K1y, it is possible to nullify the chromaticity shift amount of the display image due to the color temperature change of the LED backlight as indicated by the dotted lines shown in FIG. 6. The memory 8 stores in advance the first look-up table that indicates the corresponding relationship between the LED temperature and the temperature correction values K1x and K1y. Because of this, in the computation process in the step S50, the CPU 5 decides the temperature correction values K1x and K1y, which correspond to the average value of the detected LED temperatures, with reference to the above first look-up table.

Besides, between the panel operation integrated time of the liquid crystal display panel P1 and the chromaticity shift amount of the display image due to the deterioration of the liquid crystal display panel P1, there is the relationship as shown in FIG. 7; and by compensating for the deterioration of the liquid crystal display panel P1 by means of the deterioration correction values K2x and K2y, it is possible to nullify the chromaticity shift amount of the display image due to the deterioration of the liquid crystal display panel P1 as indicated by the dotted lines shown in FIG. 7. The memory 8 stores in advance the second look-up table that indicates the corresponding relationship between the panel operation integrated time of the liquid crystal display panel P1 and the deterioration correction values K2x and K2y. Because of this, in the computation process in the step S50, the CPU 5 decides the deterioration correction values K2x and K2y, which correspond to the panel operation integrated time that is read out in the step S30, with reference to the above second look-up table.

In the final stage of the computation process in the step S50, the CPU 5 computes the color temperature correction values (K1x+K2x, K1y+K2y). And, in the step S60 that follows the step S50, the CPU 5 changes the color temperature correction values to be output to the color temperature adjustment circuit 7 in accordance with the computation result obtained in the step S50.

The operations of the steps S60 to S90 are the same as the first embodiment, accordingly, the description is skipped.

According to the above operation, the color temperature change of the LED backlight and the deterioration of the liquid crystal display panel P1 are compensated; and the chromaticity shift amount of the display image is curbed.

Hereinbefore, the embodiments of the present invention are described; however, the scope of the present invention is not limited to the embodiments; it is possible to add various modifications without departing from the spirit of the present invention and perform them.

For example, in the above embodiments, the digital television receiver including the edge-type LED backlight unit is described as an example; however, the present invention is also applicable to a digital television receiver that includes a direct-type LED backlight unit. In a digital television receiver that includes a direct-type LED backlight unit, the LED driver usually serves as a drive circuit for a plurality of channel outputs; accordingly, like the above first embodiment, in the case where the voltage step-down circuit is disposed, it is ideal to dispose the voltage step-down circuits for the plurality of channels; however, a structure may be employed in which the voltage step-down circuit is disposed for only one channel.

Besides, the LED driver is usually of the constant electric-current output type as in the above embodiments; however, the present invention is applicable to a case where the LED driver is of constant voltage output type. For example, in a case where the LED driver is of the constant voltage output type and the voltage step-down circuit is disposed as in the above first embodiment, it is sufficient if the voltage step-down circuit steps down the voltage, which is proportional to the drive electric current output from the LED driver, to a voltage that the CPU is able to directly read; and supplies the voltage to the CPU.

Besides, in the above embodiments, the deterioration of the liquid crystal display panel is compensated; however, in the present invention, the compensation for the deterioration of the liquid crystal display panel is not an essential condition, so that it is also possible to modify the embodiments into an embodiment in which the panel operation integrated time and the second look-up table are not stored.

What is claimed is:

1. A display apparatus comprising:
a display panel;
an LED backlight unit that emits light to the display panel;
an LED driver that drives an LED of the LED backlight unit;
an LED temperature detection portion that detects an LED temperature of the LED backlight unit; and
a correction portion that based on a detection result from the LED temperature detection portion, corrects an image signal to be supplied to the display panel to compensate for a color temperature change of the LED backlight unit.

2. The display apparatus according to claim 1, wherein the LED temperature detection portion uses an output from the LED driver to detect the LED temperature of the LED backlight unit.

3. The display apparatus according to claim 2, wherein
the LED driver is a driver of constant electric-current output type; and
the LED temperature detection portion uses an output voltage from the LED driver to detect the LED temperature of the LED backlight unit.

4. The display apparatus according to claim 1, wherein
the correction portion stores in advance a first look-up table that indicates a corresponding relationship between the LED temperature and a temperature correction value;
decides the temperature correction value, which corresponds to the LED temperature detected by the LED temperature detection portion, with reference to the first look-up table; and
based on the decided temperature correction value, corrects the image signal to be supplied to the display panel.

5. The display apparatus according to claim 2, wherein
the correction portion stores in advance a first look-up table that indicates a corresponding relationship between the LED temperature and a temperature correction value;
decides the temperature correction value, which corresponds to the LED temperature detected by the LED temperature detection portion, with reference to the first look-up table; and
based on the decided temperature correction value, corrects the image signal to be supplied to the display panel.

6. The display apparatus according to claim 3, wherein
the correction portion stores in advance a first look-up table that indicates a corresponding relationship between the LED temperature and a temperature correction value;
decides the temperature correction value, which corresponds to the LED temperature detected by the LED temperature detection portion, with reference to the first look-up table; and
based on the decided temperature correction value, corrects the image signal to be supplied to the display panel.

7. The display apparatus according to claim 1, wherein
the correction portion, based on the detection result from the LED temperature detection portion and an integrated operation time of the display panel, corrects the image signal to be supplied to the display panel to compensate for the color temperature change of the LED backlight unit and deterioration of the display panel.

8. The display apparatus according to claim 2, wherein
the correction portion, based on the detection result from the LED temperature detection portion and an integrated operation time of the display panel, corrects the image signal to be supplied to the display panel to compensate for the color temperature change of the LED backlight unit and deterioration of the display panel.

9. The display apparatus according to claim 3, wherein
the correction portion, based on the detection result from the LED temperature detection portion and an integrated operation time of the display panel, corrects the image signal to be supplied to the display panel to compensate for the color temperature change of the LED backlight unit and deterioration of the display panel.

10. The display apparatus according to claim 4, wherein
the correction portion, based on the detection result from the LED temperature detection portion and an integrated operation time of the display panel, corrects the image signal to be supplied to the display panel to compensate for the color temperature change of the LED backlight unit and deterioration of the display panel.

11. The display apparatus according to claim 5, wherein
the correction portion, based on the detection result from the LED temperature detection portion and an integrated operation time of the display panel, corrects the image signal to be supplied to the display panel to compensate for the color temperature change of the LED backlight unit and deterioration of the display panel.

12. The display apparatus according to claim 6, wherein
the correction portion, based on the detection result from the LED temperature detection portion and an integrated operation time of the display panel, corrects the image signal to be supplied to the display panel to compensate for the color temperature change of the LED backlight unit and deterioration of the display panel.

13. The display apparatus according to claim 7, wherein
the correction portion stores in advance a second look-up table that indicates a corresponding relationship between the integrated operation time of the display panel and a deterioration correction value;
decides the deterioration correction value, which corresponds to the integrated operation time of the display panel, with reference to the second look-up table; and
based on the temperature correction value that is decided with reference to the first look-up table and the deterioration correction value that is decided with reference to the second look-up table, corrects the image signal to be supplied to the display panel.

14. The display apparatus according to claim 8, wherein
the correction portion stores in advance a second look-up table that indicates a corresponding relationship between the integrated operation time of the display panel and a deterioration correction value;
decides the deterioration correction value, which corresponds to the integrated operation time of the display panel, with reference to the second look-up table; and
based on the temperature correction value that is decided with reference to the first look-up table and the deterioration correction value that is decided with reference to the second look-up table, corrects the image signal to be supplied to the display panel.

15. The display apparatus according to claim 9, wherein
the correction portion stores in advance a second look-up table that indicates a corresponding relationship between the integrated operation time of the display panel and a deterioration correction value;
decides the deterioration correction value, which corresponds to the integrated operation time of the display panel, with reference to the second look-up table; and
based on the temperature correction value that is decided with reference to the first look-up table and the deterioration correction value that is decided with reference to the second look-up table, corrects the image signal to be supplied to the display panel.

16. The display apparatus according to claim 10, wherein
the correction portion stores in advance a second look-up table that indicates a corresponding relationship between the integrated operation time of the display panel and a deterioration correction value;
decides the deterioration correction value, which corresponds to the integrated operation time of the display panel, with reference to the second look-up table; and
based on the temperature correction value that is decided with reference to the first look-up table and the deterioration correction value that is decided with reference to the second look-up table, corrects the image signal to be supplied to the display panel.

17. The display apparatus according to claim 11, wherein
the correction portion stores in advance a second look-up table that indicates a corresponding relationship between the integrated operation time of the display panel and a deterioration correction value;
decides the deterioration correction value, which corresponds to the integrated operation time of the display panel, with reference to the second look-up table; and
based on the temperature correction value that is decided with reference to the first look-up table and the deterioration correction value that is decided with reference to the second look-up table, corrects the image signal to be supplied to the display panel.

18. The display apparatus according to claim 12, wherein
the correction portion stores in advance a second look-up table that indicates a corresponding relationship between the integrated operation time of the display panel and a deterioration correction value;
decides the deterioration correction value, which corresponds to the integrated operation time of the display panel, with reference to the second look-up table; and
based on the temperature correction value that is decided with reference to the first look-up table and the deterioration correction value that is decided with reference to the second look-up table, corrects the image signal to be supplied to the display panel.
